(19) United States
(12) Patent Application Publication
(10) Pub. No.: US 2010/0224317 A1
(43) Pub. Date: Sep. 9, 2010

(54) METHOD FOR FORMING GRAFT POLYMER PATTERN AND METHOD FOR FORMING ELECTRICALLY CONDUCTIVE PATTERN

(75) Inventor: Koichi Kawamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/997,248

(22) PCT Filed: Jul. 24, 2006
(86) PCT No.: PCT/JP2006/315076

§ 371 Date: Jan. 29, 2008

(30) Foreign Application Priority Data
Jul. 29, 2005 (JP) 2005-222169
Jul. 29, 2005 (JP) 2005-222209

(51) Int. Cl. B05D 5/12; B32B 37/12

(52) U.S. Cl. 156/277; 427/58

(57) ABSTRACT

The invention discloses a method for forming a graft polymer pattern including disposing in a pattern a liquid containing a radically polymerizable unsaturated compound on a substrate surface capable of generating radicals by heating or exposure, and heating or exposing the substrate to form a graft polymer directly bonded to the substrate surface in a region where the liquid has been disposed. The invention also discloses a method for forming an electrically conductive pattern including attaching an electrically conductive substance to the graft polymer thus formed.

### TECHNICAL FIELD

The invention relates to a method for forming a pattern and a method for forming an electrically conductive pattern, and particularly to a method for forming a graft polymer pattern that enables easy formation of a pattern having excellent resolution on a solid surface, and a method for forming an electrically conductive pattern useful as a metal circuit board and a printed circuit board.

### BACKGROUND ART

Surface modification of a solid surface with a polymer has been widely studied in various industrial fields because such surface modification can alter properties such as wettability, stain resistance, adhesiveness, surface friction, and affinity for cells. In particular, surface modification with a surface graft polymer in which surface modification a polymer is directly bonded to a solid surface through a covalent bond is known to have the following advantages. That is, a strong bond is formed between the surface and the polymer. Moreover, the affinity of the graft polymer for a substance is significantly different from the affinity of a polymer formed by a general coating and cross-linking method, and the surface modification thus exhibits specific properties derived from the difference in affinity.

Applied technologies have been proposed which use the surface graft polymers having such advantages in various fields such as the field of living bodies (for example, cell cultures, antithrombotic artificial blood vessels, and artificial joints), hydrophilic films and hydrophilic supports of printing plates whose surface has to have high hydrophilicity. These applications utilize the specific properties of the graft polymers.

Furthermore, when such a surface graft polymer is formed in a pattern, the specific properties of the graft polymer can be exhibited according to the pattern. Therefore, the graft polymer pattern is used for various applications such as printing plate precursors, compartmentalized cultures and dye image formation.

For example, Matsuda et al., “Journal of Biomedical Materials Research”, Vol. 53, page 584 (2000), reports that a hydrophilic graft pattern is formed by using a polymerization initiating group (called an “iniferter”) fixed on a surface, and used as a cellular compartmentalized culture material. Moreover, Matsuda et al., “Langumuir”, Vol. 15, page 5560 (1999), reports that a dye (toluidine blue) is adsorbed by a graft polymer pattern to form a visible image pattern.

Furthermore, A. T. Metters et al., “Macromolecules”, Vol. 36, page 6739 (2003), reports a technique for polymerizing a hydrophilic or hydrophobic monomer in a pattern using an iniferter polymerization initiator to form a graft polymer pattern, and a technique for grafting a monomer having a dye structure to form a dye polymer pattern.

C. J. Hawker et al., “Macromolecules”, Vol. 33, page 597 (2000), reports a method for attaching an initiator in an imagewise manner onto a gold plate using a micro-contact printing method, causing atom transfer polymerization (ATRP polymerization) from the initiator to form a graft polymer of hydroxyethyl methacrylate (HEMA) or methyl methacrylate (MMA) in a pattern, and using the obtained pattern as a resist.

In addition, Ingall et al., “J. Am. Chem. Soc”, Vol. 121, page 3607 (1999), proposes a method for forming a graft polymer pattern by anion radical polymerization or cation radical polymerization starting at a silane compound fixed on a substrate.

However, the formation of a graft polymer pattern on a solid surface by the aforementioned conventional iniferter method and the atom transfer polymerization method takes an excessively long reaction time to provide sufficient suitability for manufacture. The method using anion radical polymerization or cation radical polymerization also provides insufficient suitability for manufacture because it requires precise control of the polymerization reaction.

As recited above, a pattern forming method using modification of a solid surface with a graft polymer is demanded for obtaining an effective surface-modified material or a high performance material, but a method capable of easily forming a graft polymer in a practical manufacturing time has not been obtained.

In the meantime, various electrically conductive patterns have been heretofore used as wiring boards. A typical method for forming such an electrically conductive pattern includes forming a thin film of an electrically conductive material on an insulating material by a known process such as a vacuum deposition process, providing a resist layer on the thin film, pattern-wise exposing the resist film to light so as to remove a part of the resist film, and then etching the electrically conductive material to form a desired pattern (see Japanese Patent Application Laid-Open (JP-A) No. 2004-31588). This method requires at least four steps, and, when a wet etching process is carried out, further needs a step of disposing the waste liquid. Therefore, the method is inevitably complicated.

As another pattern forming method, an electrically conductive pattern forming method using a photoresist is known. This method includes exposing a substrate that is coated with a photoresist polymer or to which a dry film of a photoresist is stuck to ultraviolet light through a photomask having a desired opening or openings to form, for example, a lattice-shaped pattern. This method is useful in forming an electromagnetic wave shield, which requires a high electrical conductivity.

On the other hand, various methods have been recently proposed which enables patterns to be formed directly from digital data without using masks.

It is expected that any pattern can be formed by using such a digitized pattern forming method. In one of such methods, a self-organizing monomolecular film is used. This method uses molecular aggregates that spontaneously occur when a substrate is immersed in an organic solvent containing surfactant molecules. Examples of combinations of the organic solvent and the substrate include a combination of an organic silane compound and an SiO₂ or Al₂O₃ substrate, and a combination of alcohol or amine and a platinum substrate. The pattern can be formed by, for example, a photolithographic method. Such a monomolecular film enables formation of a fine pattern, but is difficult to put into practical use. This is because there is a limit to available combinations of the substrate and the organic solvent. Accordingly, practical techniques for forming an electrically conductive patterns such as wiring have not been developed.

Therefore, there is a need for a method capable of easily forming a graft polymer pattern having high resolution on a solid surface.

Also, there is a need for a method capable of forming an electrically conductive pattern having high resolution, excellent electrical conductivity and durability without requiring complicated steps and expensive equipment.

### DISCLOSURE OF INVENTION

A first aspect of the invention provides a method for forming a graft polymer pattern including disposing in a pattern a liquid containing a radically polymerizable unsaturated compound on a substrate surface capable of generating radicals by heating or exposure, and heating or exposing the substrate to form a graft polymer directly bonded to the substrate surface in a region where the liquid has been disposed.

A second aspect of the invention provides a method for forming an electrically conductive pattern including: disposing in a pattern a liquid containing a radically polymerizable unsaturated compound on a substrate surface that can generate radicals by heating or exposure; heating or exposing the substrate to form a graft polymer directly bonded to the substrate surface in a region where the liquid has been disposed; and attaching an electrically conductive substance to the graft polymer

In the method for forming a graft polymer pattern and the method for forming an electrically conductive pattern of the invention, disposing in a pattern the liquid containing a radically polymerizable unsaturated compound is preferably conducted by a process selected from the group consisting of an ink jet process, a stamp process and a printing process. In particular, when these methods include an ink jet process, the liquid can be attached in the pattern to the substrate according to digital data. Therefore, these methods have widespread application.

According to the method of the invention, a liquid containing a radically polymerizable unsaturated compound is disposed in a pattern on the surface of a substrate capable of generating radicals by heating or exposure, by a known process, for example, an ink jet process, a stamp process and/or a printing process. Thereafter, a graft polymer is formed in the region(s) where the liquid has been disposed by simply heating or wholly exposing the substrate that has been brought into contact with the unsaturated compound. As a result, a graft polymer pattern having at least one region where a graft polymer has been formed and at least one region where the graft polymer has not been formed.

In the invention, a graft polymer is formed through polymerization reaction started by free radicals on the substrate surface, and the polymerization reaction proceeds fast and does not require precise control.

For these, the method for forming a graft polymer pattern of the invention enables easy formation of a graft polymer pattern.

When an electrically conductive substance is selectively attached to the graft polymer thus formed, or, in other words, when the electrically conductive substance is selectively attached to the region(s) where the graft polymer has been formed, an electrically conductive pattern is formed.

The method for forming an electrically conductive pattern of the invention enables production of an electrically conductive pattern where an electrically conductive substance is selectively attached to a graft polymer without requiring complicated steps and expensive equipment. The electrically conductive pattern has a resolution that corresponds to the accuracy of the graft pattern, and has excellent electrical conductivity and durability.

### BEST MODE FOR CARRYING OUT THE INVENTION

The invention will be described in detail below.

The method for forming a graft polymer pattern of the invention includes: (1) disposing in a pattern a liquid containing at least one radically polymerizable unsaturated compound (hereinafter referred to as a radically polymerizable compound in some cases) on a substrate surface capable of generating radicals by heating or exposure (hereinafter referred to as “liquid disposition”); and (2) heating or exposing the substrate to form a graft polymer in the region(s) where the liquid has been disposed (hereinafter referred to as “graft polymer formation”).

The method for forming an electrically conductive pattern of the invention includes: (1) disposing in a pattern a liquid containing at least one radically polymerizable unsaturated compound on a substrate surface capable of generating radicals by heating or exposure; heating or exposing the substrate to form a graft polymer in the region(s) where the liquid has been disposed; and attaching at least one electrically conductive substance to the graft polymer (hereinafter referred to as “electrically conductive substance attachment”).

The following sections describes in detail the steps of the methods in the invention and materials required therein, for example, a process for disposing a liquid in a pattern, a substrate capable of generating radicals by heating or exposure, a radically polymerizable unsaturated compound (radical-polymerizable compound), and a solvent for dissolving or dispersing the radically polymerizable unsaturated compound.

Liquid Disposition

Process for Disposing Liquid in Pattern

In the invention, a liquid containing at least one radically polymerizable compound is locally disposed on the surface of a substrate by, for example, an ink jet process in which a liquid is discharged in a pattern with an ink jet printer, a stamp process such as a contact printing process or a micro-contact printing process, or a printing process such as a screen printing process, a flexographic printing process, a gravure printing process or a lithographic process.

The stamp process includes dipping a rubber stamp with a pattern having at least one convex portion and at least one concave portion on the surface thereof, in a liquid containing at least one fluid radically polymerizable compound, and pressing the rubber stamp against the surface of a substrate to transfer the liquid containing at least one radically polymerizable compound from the convex portion(s) of the rubber stamp to the surface of the substrate. The rubber stamp is made of at least one of natural rubbers, silicone rubbers and elastomers having appropriate flexibility, and has a surface with at least one concave portion and at least one convex portion used to transfer a desired pattern to the surface of the substrate. When the rubber stamp has a pattern with lines and spaces whose widths are several hundreds μm to several mm, the rubber stamp can be made by preparing a metal die having at least one groove in the surface portion thereof and pouring a rubber stamp material into the at least one groove. When the rubber stamp has a pattern with lines and spaces whose widths are several tens nm or more but less than twenty μm, such as a rubber stamp used in micro-contact printing, the rubber stamp can be made by etching with a resist.

In the printing process such as a screen printing, flexographic printing, gravure printing, lithography or other printing process, a liquid containing at least one radically polymerizable compound is transferred to a substrate surface.

In the ink jet process, droplets of a liquid containing at least one radically polymerizable compound, the amount of each of which droplets is of a picoliter order, are discharged from liquid discharge holes toward a substrate in accordance with recording signals (digital data) to form a pattern. The ink jet process is an excellent process for forming a fine pattern.

Substrate Surface Capable of Generating Radicals by Heating or Exposure

Examples of the substrate capable of generating radicals by heating or exposure that can be used in the invention include: (a) a substrate containing at least one low-molecular-weight radical-generating agent; (b) a substrate containing at least one polymer compound having at least one radical-generating moiety in the main chain or the side chain(s); and (c) a substrate prepared by applying at least one application liquid containing at least one polymer compound having at least one cross-linkable moiety and at least one radical-generating moiety in the side chain(s) to a support surface, drying the resultant coating, and forming a cross-linked structure in the coating.

The substrates (a) and (b) may contain at least one radical-generating agent as at least one of the components thereof, or may have a support, which can be made of any material, and, on the support, at least one layer that contains at least one low-molecular-weight or high-molecular-weight radical-generating agent (radical generating agent-containing layer). When the substrate has a support and a radical generating agent-containing layer, a subbing layer may be provided between the support and the radical generating agent-containing layer to improve adhesiveness therebetween.

Furthermore, the substrate may be a special material, namely, (d) a substrate having a support and a layer made of at least one photopolymerization-initiating moiety that can initiate radical polymerization by photocleavage and connected through at least one covalent bond with the surface of the support. More specifically, the surface of the support is connected with a compound having such a photopolymerization-initiating moiety capable of initiating radical polymerization by photocleavage and a moiety binding to the support.

The low-molecular-weight radical-generating agent used in the substrate (a) may be a known radical-generating agent. Examples thereof include acetophenones, benzophenones, Michler's ketone, benzoyl benzoate, benzoins, α-acyloxime esters, tetramethylthiuram monosulfide, trichloromethyltriazine and thioxanthone. Moreover, sulfonium salts and iodonium salts, which are usually used as a photo acid-generating agent, may also be used in the invention, since these salts also serve as a radical-generating agent when exposed to light.

Examples of the high-molecular-weight radical-generating agent used in the substrate (b) include polymer compounds having at least one active carbonyl group in the side chain(s) and described in paragraph Nos. 0012 to 0030 of JP-A No. H09-77891 and in paragraph Nos. 0020 to 0073 of JP-A No. H10-45927.

The molecular weight of the high-molecular-weight radical-generating agent is preferably 1,000 to 300,000, and, from the viewpoint of manufacturing control during synthesis, more preferably 3,000 to 100,000.

The amount of the low-molecular-weight radical-generating agent and/or the high-molecular-weight radical-generating agent can be appropriately selected in consideration of the type of the substrate, the yield of a desired graft polymer or other factors.

In general, the content of the low-molecular-weight radical-generating agent(s) is preferably in the range of 0.1% to 40% by mass with reference to the total solid content of the substrate or the radical-generating agent-containing layer. The content of the high-molecular-weight radical-generating agent(s) is preferably in the range of 1.0% to 50% by mass with reference to the total solid content of the substrate or the radical-generating agent-containing layer.

In addition to the low-molecular-weight radical-generating agent(s) and/or the high-molecular-weight radical-generating agent(s), at least one sensitizer may be contained in the substrate to improve sensitivity. Examples of the sensitizer include n-butylamine, triethylamine, tri-n-butyl phosphine and thioxanthone derivatives.

The content of the sensitizer(s) is preferably 50% to 200% by mass with reference to that of the radical-generating agent(s).

The substrate (c) has, more specifically, a support, which can be made of any material, and at least one polymerization initiating layer obtained by fixing at least one polymer, which has at least one functional group capable of initiating polymerization and at least one cross-linkable group in the side chain(s), on the support by cross-linking reaction. Such a polymerization initiating layer can generate radicals by heating or exposure.

A method for forming such a polymerization initiating layer is described in detail, for example, in JP-A No. 2004-123837. The polymerization initiating layer described therein can be used in the invention.

Thus, the polymerization initiating layer has a cross-linked structure. Therefore, even when the polymerization initiating layer is brought into contact with, for example, a liquid monomer component, more specifically a radically polymerizable compound, the polymerization initiating component of the layer is prevented from undesirably seeping into the liquid. In addition, since such a polymerization initiating layer has a high film strength, it is possible to conduct efficient radical polymerization reaction. Moreover, adhesiveness between the generated graft polymer and the substrate can be strong.

The substrate (d) has a support having a surface connected through at least one covalent bond with at least one photopolymerization-initiating moiety capable of initiating radical polymerization by photocleavage and a moiety binding to the support. The support can be made of any material. The photopolymerization-initiating moiety is connected to the support surface via the moiety binding to the support. The linkage between the support surface and the photopolymerization-initiating moiety is preferably a covalent bond such as an O—C, O—Si, N—C, N—Si, S—C, S—Si or S—O bond.

Examples of the compound having at least one photopolymerization-initiating moiety, which can generate an active site that initiates graft polymerization, and a moiety binding to a support are shown below, but the invention is not limited by these compounds. These compounds are fixed onto the support surface by chemical reaction between a moiety that can bind to the support and becomes the moiety binding to the support, and the support surface.

Compounds having C—C bond that can cleave

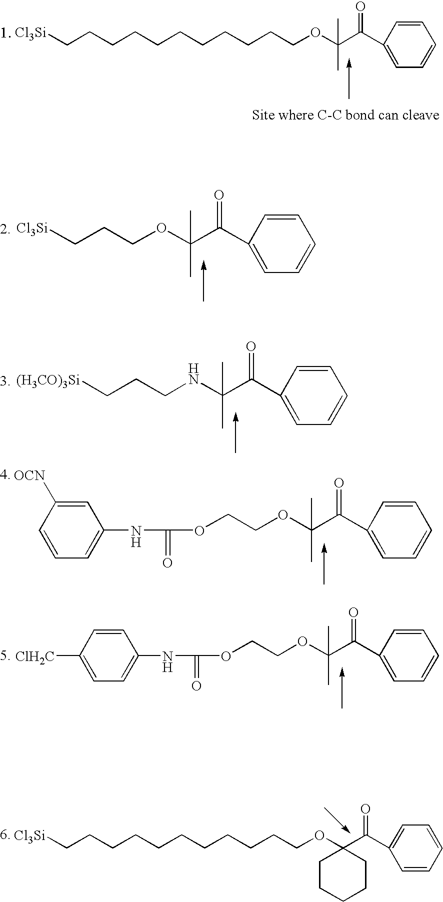

Compounds having C—O bond that can cleave

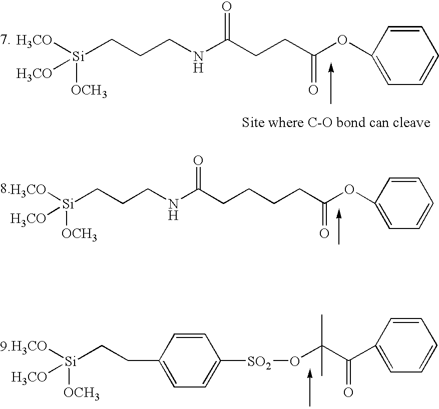

Compounds having S—N bond that can cleave

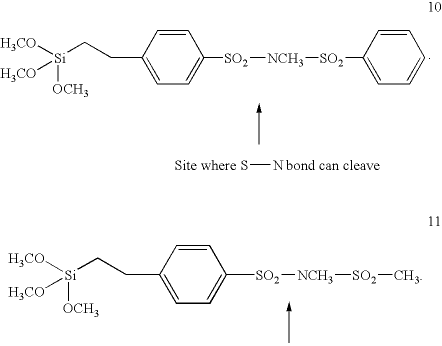

Compounds having C—N bond that can cleave

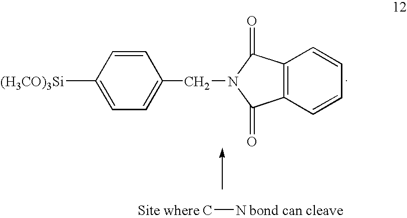

Compounds having N—O bond that can cleave

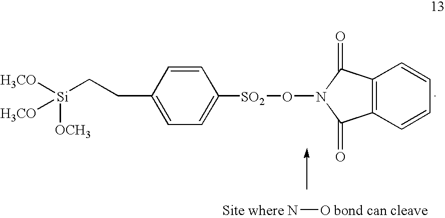

Compounds having C—Cl bond that can cleave

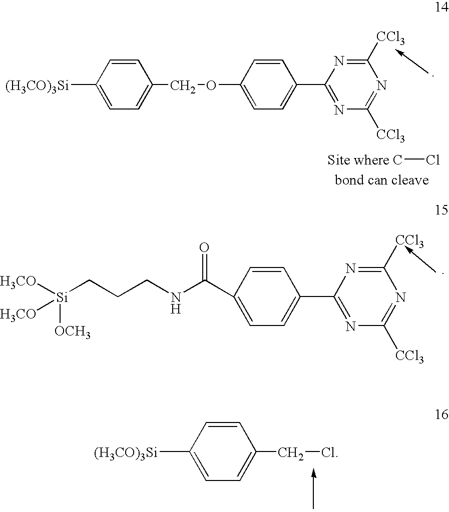

The substrate used in the invention may be any one of the above-described substrates (a) to (d) and should have physical properties suitable for the intended use and otherwise there is no limit thereto. The material(s) of the substrate may be an organic material, an inorganic material or a composite material of at least one organic material and at least one inorganic material.

The organic material(s) serving as the substrate (support) material may be appropriately selected from acrylic resins such as polymethyl methacrylate, polyester resins such as polyethylene terephthalate, polyethylene naphthalate, poly-1,4-cyclohexanedimethylene terephthalate, polyethylene-1,2-diphenoxyethan-4,4′-dicarboxylate and polybutylene terephthalate, epoxy resins including a commercial product available from Yuka-Shell Epoxy Co. Ltd. as EPIKOTE, polycarbonate resins, polyimide resins, novolac resins, phenol resins, cellulose esters such as triacetylcellulose, diacetylcellulose, propionylcellulose, butyrylcellulose, acetylpropionylcellulose and nitrocellulose, polyamides, polystyrenes such as syndiotactic polystyrene, polyolefins such as polypropylene, polyethylene and polymethylpentene, polysulfones, polyether sulfones, polyarylates, polyether imides and polyether ketones.

The inorganic material(s) serving as the substrate (support) material may be glass, quartz, silicon, a metal such as iron, zinc, copper or stainless steel, a metal oxide such as tin oxide and zinc oxide, or ITO. A composite material of at least two of these materials may also be used as the substrate material.

More specifically, the material(s) of the substrate (a) or (b) may be a plastic material such as PET, polypropylene, polyimide or an acrylic resin.

When the substrate (a) or (b) has a support, which can be made of any material, and, on the support, a radical-generating agent-containing layer, or when the substrate (c) has a support, which can be made of any material, and, on the support, a polymerization-initiating layer, the support may be made of an organic material and/or an inorganic material.

In the substrate (c), the material of the support whose surface is provided with a coating layer having a cross-linked structure may be a plastic material such as PET, polypropylene, polyimide or an acrylic resin.

It is necessary that the support of the substrate (d), which is connected with the compound having at least one photopolymerization-initiating moiety capable of initiating radical polymerization by photocleavage and at least one moiety binding to the support, has at least one functional group such as a hydroxyl group, a carboxyl group or an amino group on its surface, or is subjected to surface treatment such as corona treatment, glow treatment and/or plasma treatment to generate, for example, at least one of hydroxyl groups and carboxyl groups. The support may be a support that is made of, for example, glass, quartz, ITO, a silicon resin or an epoxy resin and that therefore has at least one hydroxyl group on the surface thereof, or a support that is made of at least one plastic material such as PET, polypropylene, polyimide, an epoxy resin, an acrylic resin, or a urethane resin and that have been subjected to surface treatment such as corona treatment, glow treatment and/or plasma treatment to generate at least one of hydroxyl groups and carboxyl groups on the surface thereof.

The thickness of the substrate (support) is selected in accordance with the intended use, and is not specifically limited, but is usually in the range of 10 μm to 10 cm.

When the substrate (support) is made of at least one organic material, the substrate may also contain a compound or compounds necessary for the intended use of a graft pattern to be formed on the substrate.

For example, when the substrate contains at least one compound having a radically polymerizable double bond, the substrate has improved strength. The compound having a radically polymerizable double bond is, for example, an acrylate or methacrylate compound. The (meth)acrylate compound that can be used in the invention has an acryloyl group, which is an ethylenically unsaturated group, in the molecule and otherwise there is no limit thereto. However, the (meth)acrylate compound is preferably a polyfunctional monomer from the viewpoints of improved strength and hardness of the substrate surface and curability.

The polyfunctional monomer that can be used in the invention is preferably an ester of polyhydric alcohol(s) and acrylic acid or methacrylic acid. Examples of the polyhydric alcohol include ethylene glycol, 1,4-cyclohexanol, pentaerythritol, trimethylolpropane, trimethylolethane, dipentaerythritol, 1,2,4-cyclohexanol, polyurethane polyol and polyester polyol. Among them, the polyhydric alcohol is preferably trimethylol propane, pentaerythritol, dipentaerythritol or polyurethane polyol. The substrate may contain two or more of such polyfunctional monomers.

The polyfunctional monomer contains at least two ethylenically unsaturated groups in the molecule, and preferably contains three or more ethyleneically unsaturated groups. Specifically, the polyfunctional monomer is, for example, a polyfunctional acrylate monomer containing 3 to 6 acrylate groups in the molecule. Furthermore, at least one of oligomers having several acrylate groups in the molecule and a molecular weight of several hundreds to several thousands, which are referred to as urethane acrylate, polyester acrylate and epoxy acrylate, is also preferably used as one of the components of the substrate in the invention.

Specific examples of the acrylate having three or more acrylic groups in the molecule include polyol polyacrylates such as trimethylolpropane triacrylate, ditrimethylolpropane tetraacrylate, pentaerythritol triacrylate, pentaerythritol tetraacrylate, dipentaerythritol pentaacrylate and dipentaerythritol hexaacrylate, and urethane acrylates obtained by reacting polyisocyanate with acrylate containing at least one hydroxy group such as hydroxyethyl acrylate.

The substrates (a) and (b) may contain in the inside portion thereof or on the surface portion thereof at least one sensitizer as well as the low-molecular-weight radical-generating agent(s) and/or the high-molecular-weight radical-generating agent(s) to improve sensitivity of the substrates. Examples of the sensitizer include n-butylamine, triethylamine, tri-n-butyl phosphine and thioxanthone derivatives.

The substrate used in the invention may contain at least one dye sensitizer such as a merocyanine dye, a cyanine dye, a benzylidene dye, a stilbene dye or a polynuclear aromatic compound to obtain spectral sensitivity in the long wave side of the visible range. The amount of the sensitizer(s) is preferably about 50 to 200 parts by weight with reference to 100 parts by weight of the low-molecular-weight radical-generating agent(s) and/or the high-molecular-weight radical-generating agent(s).

The substrate used in the invention may further contain any other component(s) in accordance with the intended use. It is important that the inside portion of the substrate contains at least one (meth)acrylate compound having at least one unsaturated double bond in the molecule in addition to the low-molecular-weight radical-generating agent(s) and/or the high-molecular-weight radical-generating agent(s). The (meth)acrylate compound is preferably a polyfunctional (meth)acrylate from the viewpoints of curability of the substrate and a property of generating a graft starting point or points.

As described above, the liquid containing at least one radically polymerizable compound is disposed in a pattern on the substrate surface capable of generating radicals, and heating the substrate or exposing the substrate to light causes radical polymerization to start at the substrate surface, forming a graft polymer.

Radically Polymerizable Unsaturated Compound (Radically Polymerizable Compound)

In the invention, the radically polymerizable compound may be any of compounds having at least one radically polymerizable group. Examples thereof include hydrophilic monomers, hydrophobic monomers, macromers, oligomers and polymers each having at least one radically polymerizable unsaturated group.

When electrically conductive substance attachment, which will be described later, is conducted, it is preferable that the type of the radically polymerizable compound(s) is appropriately selected in accordance with the conditions of the electrically conductive substance attachment. More specifically, the radically polymerizable compound preferably has at least one of functional groups that can directly interact with at least one electrically conductive substance and functional groups that can interact with at least one material used to effectively hold at least one electrically conductive material, in order to allow the formed graft polymer to hold the electrically conductive substance effectively, easily and at a high density.

The functional groups that can directly interact with at least one electrically conductive material and the functional groups that can interact with at least one material used to effectively hold at least one electrically conductive material are comprehensively referred to as interactive groups, which will be described below.

Each of the interactive groups is, for example, a polar group. More specifically, the interactive group is preferably a hydrophilic group. Specific examples thereof include ionic groups having a positive charge such as ammonium and phosphonium groups; ionic groups having a negative charge such as a sulfonic acid group, a carboxyl group, a phosphoric acid group and a phosphonic acid group; and nonionic groups such as a hydroxyl group, an amide group, a sulfoneamide group, an alkoxy group and a cyano group.

Examples of the radically polymerizable compound preferably used to form a graft polymer in forming an electrically conductive pattern include hydrophilic monomers having at least one of the above-described hydrophilic groups, hydrophilic macromonomers and polymers having at least one hydrophilic group and at least one radically polymerizable unsaturated group.

Examples of the hydrophilic monomer include monomers each having at least one functional group that has a positive charge such as ammonium and phosphonium groups; monomers each having at least one acidic group, which has a negative charge or which can dissociate to generate a negative charge, such as a sulfonic acid group, a carboxyl group, a phosphoric acid group and a phosphonic acid group; and hydrophilic monomers having at least one nonionic group such as a hydroxyl group, an amide group, a sulfonamide group, an alkoxy group or a cyano group.

Specific examples of the hydrophilic monomer that can be used in the invention include (meth)acrylic acid and alkali metal and amine salts thereof; itaconic acid and alkali metal and amine salts thereof, allylamine, and hydrohalogenic acid salts thereof, 3-vinylpropionic acid and alkali metal and amine salts thereof, vinylsulfonic acid and alkali metal and amine salts thereof, styrenesulfonic acid and alkali metal and amine salts thereof, 2-sulfoethylene (meth)acrylate and 3-sulfopropylene (meth)acrylate and alkali metal and amine salts thereof, 2-acrylamide-2-methylpropanesulfonic acid and alkali metal and amine salts thereof, acid phosphoxypolyoxyethylene glycol mono(meth)acrylate and salts thereof, 2-dimethylaminoethyl(meth)acrylate and hydrohalogenic acid salts thereof, 3-trimethylammonium propyl(meth)acrylate, 3-trimethylammoniumpropyl(meth)acrylamide, N,N,N-trimethyl-N-(2-hydroxy-3-methacryloyloxypropyl)ammonium chloride, 2-hydroxyethyl(meth)acrylate, (meth)acrylamide, N-monomethylol (meth)acrylamide, N-dimethylol (meth)acrylamide, N-vinylpyrrolidone, N-vinylacetamide, and polyoxyethylene glycol mono(meth)acrylate.

Examples of the hydrophobic monomer include actylates such as methyl (meth)acrylate, and vinyl monomers such as styrene.

A method for producing the macromonomer which can be used in the invention can be any of methods suggested in Chapter 2 “Synthesis of Macromonomers” of Chemistry and Industry of Macromonomer edited by Yuya Yamashita, and published by IPC Shuppankyoku in Sep. 20, 1989.

Typical examples of the hydrophilic macromonomer employable herein include macromonomers derived from carboxyl group-containing monomers such as acrylic acid and methacrylic acid, sulfonic acid-based macromonomers derived from sulfonic acid monomers such as 2-acrylamide-2-methylpropanesulfonic acid, vinylstyrenesulfonic acid and salts thereof, amide-based macromonomers derived from amide monomers such as (meth)acrylamide, N-vinylacetamide, N-vinylformamide and N-vinylcarboxylic acid amide, macromonomers derived from hydroxyl group-containing monomers such as hydroxyethyl methacrylate, hydroxyethyl acrylate and glycerol monomethacrylate, and macromonomers derived from alkoxy group or ethylene oxide group-containing monomers such as methoxyethyl acrylate, methoxypolyethylene glycol acrylate and polyethylene glycol acrylate.

Further, a monomer having at least one of polyethylene glycol chains and polypropylene glycol chains can also be used as the macromonomer in the invention.

The molecular weight of the hydrophilic macromonomer is preferably from 250 to 100,000, and more preferably from 400 to 30,000.

The polymer having at least one radically polymerizable unsaturated group refers to a radically polymerizable group-containing polymer having at least one ethylene addition-polymerizable unsaturated group such as a vinyl group, an allyl group or a (meth)acrylic group in the molecule. It is necessary that the radically polymerizable group-containing polymer have at least one polymerizable group at one or more terminals of the main chain and/or in or on the side chain(s). The radically polymerizable group-containing polymer preferably has at least one polymerizable group both at one or more terminals of the main chain and in or on the side chain(s). Such a radically polymerizable group-containing polymer can be synthesized by any of the following methods.

Examples of the synthesis method of the above polymer include (i) a method that includes copolymerizing at least one monomer with at least one monomer having at least one ethylene addition-polymerizable unsaturated group; (ii) a method that includes copolymerizing at least one monomer with at least one monomer having at least one double bond precursor, and treating the resultant copolymer with, for example, at least one base to introduce at least one double bond into the copolymer; and (iii) a method that includes reacting at least one polymer having at least one functional group with at least one monomer having at least one ethylene addition-polymerizable unsaturated group.

The polymer can further have at least one hydrophilic group. The synthesis method thereof may be: (i′) a method that includes copolymerizing at least one hydrophilic monomer with at least one monomer having at least one ethylene addition-polymerizable unsaturated group; (ii′) a method that includes copolymerizing at least one hydrophilic monomer with at least one monomer having at least one double bond precursor, and treating the resultant copolymer with, for example, at least one base to introduce at least one double bond into the copolymer; or (iii′) a method that includes reacting at least one hydrophilic polymer having at least one functional group with at least one monomer having at least one ethylene addition-polymerizable unsaturated group.

The hydrophilic monomer used in the synthesis of the radically polymerizable group-containing hydrophilic polymer can be a monomer having at least one functional group such as a carboxyl group, a sulfonic acid group, a phosphoric acid group, or an amino group or a salt thereof, a hydroxyl group, an amide group, or an ether group. Specific examples thereof include (meth)acrylic acid, alkali metal and amine salts thereof, itaconic acid and alkali metal and amine salts thereof, 2-hydroxyethyl(meth)acrylate, (meth) acrylamide, N-monomethylol (meth)acrylamide, N,N-dimethylol (meth)acrylamide, allylamine and hydrohalogenic acid salts thereof, 3-vinylpropionic acid and alkali metal and amine salts thereof, vinylsulfonic acid and alkali metal and amine salts thereof, 2-sulfoethyl (meth)acrylate, polyoxyethylene glycol mono(meth)acrylate, 2-acrylamide-2-methylpropanesulfonic acid, and acid phosphoxypolyoxyethylene glycol mono(meth)acrylate.

The monomer(s) having at least one ethylene addition-polymerizable unsaturated group which monomer is copolymerized with the monomer(s), which may be hydrophilic, in the synthesis of the radically polymerizable group-containing polymer, which may be hydrophilic, in the method (i) or (i′) is, for example, an allyl group-containing monomer. Specific examples of such an allyl group-containing monomer include allyl(meth)acrylate, and 2-allyloxyethyl methacrylate.

The monomer having at least one double bond precursor which monomer is copolymerized with the monomer in synthesizing the radically polymerizable group-containing polymer, which may be hydrophilic, in the method (ii) or (ii′) is, for example, 2-(3-chloro-1-oxopropoxy)ethyl methacrylate.

In the method (iii) or (iii′), at least one unsaturated group is preferably introduced into the polymer, which may be hydrophilic, by utilizing reaction of the carboxyl group(s), and/or the amino group(s) and/or the salt(s) thereof in the polymer with at least one functional group such as a hydroxyl group or an epoxy group in synthesizing the radically polymerizable group-containing polymer, which may be hydrophilic. At least one monomer having at least one addition-polymerizable unsaturated group can be used in the introduction. Examples of such a monomer include (meth)acrylic acid, glycidyl(meth)acrylate, allyl glycidyl ether, and 2-isocyanatoethyl(meth)acrylate.

Solvent for Dissolving or Dispersing Radically Polymerizable Compound

The solvent(s) for dissolving or dispersing the radically polymerizable compound needs to dissolve or disperse the radically polymerizable compound(s) and at least one optional additive, and otherwise there is no limit thereto.

When a hydrophilic compound such as a hydrophilic monomer is used as the radically polymerizable compound, the solvent is preferably an aqueous solvent such as water or a water-soluble solvent, or a mixture thereof. At least one surfactant may be added to the solvent. The water-soluble solvent refers to a solvent miscible with water at any mixing rate. Examples of the water-soluble solvent include alcohols such as methanol, ethanol, propanol, ethylene glycol and glycerin, acids such as acetic acid, ketones such as acetone, and amides such as formamide.

When a hydrophobic compound such as a hydrophobic monomer is used as the radically polymerizable compound, the solvent is preferably alcohol such as methanol, ethanol or 1-methoxy-2-propanol, ketone such as methyl ethyl ketone, or hydrocarbon such as toluene.

When the radically polymerizable compound is a low molecular compound that is a liquid and that has therefore fluidity, the radically polymerizable compound can be disposed in a pattern on a substrate without using a solvent.

The viscosity of the liquid containing at least one radically polymerizable compound used in the invention is preferably 1 mPa·s to 50 mPa·s. If the viscosity is lower than 1 mPa·s, such a liquid is likely to escape from a nozzle and stain the inside of a printer or a substrate in discharging the liquid by an ink jet process. If the viscosity is higher than 50 mPa·s, such a liquid is likely to frequently clog nozzle holes, making it difficult to smoothly discharge liquid droplets.

To obtain a liquid having physical properties suitable for a desired disposing method, the amount of the solvent used for the dissolution or dispersion can be appropriately adjusted.

In the invention, the liquid containing at least one radically polymerizable compound is disposed in a pattern on a substrate surface capable of generating radicals by any process selected from an ink jet process, a stamp process and a printing process. Among these processes for disposing the liquid, an ink jet process is excellent in that it enables formation of fine patterns. This is because an ink jet process enables discharge of liquid droplets, the amount of each of which is of a picoliter order, from liquid discharge holes to the substrate to form a pattern corresponding to a recording signal (digital data).

In one embodiment of the invention, droplets of the liquid are discharged from an ink jet head to portions of the substrate where a pattern is to be formed. In order to avoid bulge, it is necessary that the degree of overlapping of droplets successively discharged be controlled at this time. Alternatively, droplets of the liquid may be discharged in the following manner. A plurality of droplets are discharged in a primary discharge so that they do not overlap each other. Thereafter, a plurality of droplets are discharged in subsequent discharges so that they cover the gaps between the droplets discharged in a previous discharge or discharges.

After discharging the droplets, the substrate on which the liquid has been disposed may be dried (drying treatment) to remove the dispersion medium (solvent for the dispersion) remaining on the substrate. The liquid is changed to a dry film by the drying treatment.

The drying treatment can be performed, for example, by heating the substrate with a conventional heater such as a hot plate or an electric furnace, or by lamp annealing.

Graft Polymer Formation

After the liquid containing at least one radically polymerizable compound is disposed in a pattern on the substrate surface capable of generating radicals by heating and/or exposure in the liquid disposition, energy is given to the liquid on the substrate surface by heating the substrate and/or exposing the substrate to light. Thereby, graft polymerization is initiated at the radicals generated on the substrate surface, and a graft polymer is formed only in the region(s) of the substrate surface where the liquid has been disposed.

The heating and/or exposure to initiate or progress the graft polymerization is usually performed in air, but can be performed in an atmosphere of inert gas such as nitrogen, argon or helium gas.

Only one or both of the heating and exposure may be conducted.

The heating can be performed with a conventional hot plate or an electric furnace, or by infrared ray irradiation.

There is no special limit to the type of the light source used in the exposure. Examples thereof include an infrared lamp, a mercury vapor lamp, a metal halide lamp, a halogen lamp, a xenon lamp, a YAG laser, an argon laser, a carbon dioxide gas laser, and excimer lasers such as XeF, XeCl, XeBr, KrF, KrCl, ArF, and ArCl lasers. A light source used in ordinary exposure usually has an output of 10 W to 5,000 W. However, it is sufficient that the light source used in the embodiments of the invention has an output of 100 W to 1,000 W.

By conducting the above heating and/or exposure, reaction between the radicals generated on the substrate surface and the double bond(s) of the radically polymerizable compound(s) proceeds in the liquid containing the radically polymerizable compound(s) or the dry film obtained by drying the liquid that has been disposed in a pattern, and a graft polymer directly bonded to the substrate surface is generated only in the region(s) where the liquid has been disposed.

As described above, a high-resolution graft polymer pattern that is superior in adhesiveness with respect to the substrate and that has at least one regions where the graft polymer has been formed and at least one region where the graft polymer has not been formed is readily formed on a substrate surface in the method for forming a graft polymer pattern of the invention.

Electrically Conductive Substance Attachment

Here, an electrically conductive pattern can be obtained by attaching at least one electrically conductive substance to the graft polymer formed in the above-described graft polymer formation.

A process for attaching at least one electrically conductive substance to the graft polymer may be any of the following processes (1) to (4):

(1) process that includes causing the interactive group(s) (ionic group(s)) of the graft polymer to adsorb electrically conductive particles to form at least one electrically conductive particle-adsorbed layer (formation of electrically conductive particle-adsorbed layer);

(2) process that includes causing the interactive group(s) of the graft polymer to adsorb at least one electroless plating catalyst or at least one precursor thereof, and performing electroless plating to form at least one plating film (formation of plating film);

(3) process that includes causing the interactive group(s) of the graft polymer to adsorb at least one metal ion or at least one metal salt, and reducing the at least one metal ion or the metal ion of each of the at least one metal salt to form at least one metal particle-dispersed layer (formation of metal particle-dispersed layer); and

(4) process that includes causing the interactive group(s) of the graft polymer to adsorb at least one electrically conductivity monomer, and polymerizing the at least one monomer to form at least one electrically conductive polymer layer (formation of electrically conductive polymer layer).

These processes (1)-(4) will be described below.

(1) Formation of Electrically Conductive Particle-Adsorbed Layer

The electrically conductive particles that can be used in the process (1) need to have electrical conductivity and otherwise there is no limit thereto. The material(s) of the electrically conductive particles can be appropriately selected from known electrically conductive substances, including electrically inorganic and organic substances. Typical examples of the electrically inorganic substance include metals such as Au, Ag, Pt, Cu, Rh, Pd, Al and Cr, oxide semiconductors such as In₂O₃, SnO₂, ZnO, CdO, TiO₂, CdIn₂O₄, Cd₂SnO₂, Zn₂SnO₄ and In₂O₃—ZnO, compounds including at least one of the metals and the oxide semiconductors and further including at least one impurity serving as a dopant, spinel-type compounds such as MgInO and CaGaO, electrically conductive nitrides such as TiN, ZrN and HfN, and electrically conductive borides such as LaB. The electrically organic substance is preferably an electrically conductive polymer.

One type of electrically conductive particles may be used in the invention, or, to obtain a desired electrically conductivity, two or more types of electrically conductive particles may be used in the invention. In both cases, the electrically conductive particles can be selected from particles of the above substances.

Relationship Between Polarity of Ionic Group (Interactive Group) of Graft Polymer and Electrically Conductive Particle

When the graft polymer obtained in the invention has at least one ionic group, specifically, at least one anionic group such as a carboxyl group, a sulfonic acid group or a phosphonic acid group, the ionic group(s) of the graft polymer can selectively have a negative charge, and can adsorb (cationic) conductive particles, which have a positive charge. Examples of the cationic conductive particles include metal (oxide) particles having a positive charge. Particles having a positive charge on their surface at a high density can be prepared, for example, by a method by Toni Yonezawa et al., more specifically, a method described by T. Yonezawa, in Chemistry Letters, 1999, page 1061; Langumuir, 2000, Vol. 16, 5218; and Polymer preprillts, Japan, Vol. 49. 2911 (2000). Yonezawa et al. shows that metal particles each having a surface, which is chemically modified with at least one functional group having a positive charge at a high density, can be formed by utilizing a metal-sulfur bond.

On the other hand, when the obtained graft polymer has at least one ionic group, specifically, at least one cationic group such as an ammonium group as described in JP-A No. 10-296895, the ionic group(s) of the graft polymer selectively has a positive charge and can adsorb electrically conductive particles having a negative charge.

Examples of the negatively charged conductive particles include silver particles and gold particles obtained by citric acid reduction.

The average size of the electrically conductive particles used in the invention is preferably in the range of 0.1 nm to 1,000 nm, and more preferably in the range of 1 nm to 100 nm from the viewpoints of good adsorptivity to the ionic group(s) (interactive group(s)) and expression of good electrical conductivity.

A process for attaching electrically conductive particles to the interactive group(s) of a graft polymer is, for example, an application process including applying a solution or dispersion liquid of electrically conductive particles each having an electric charge on the surface thereof to a graft polymer, or an immersion process including immersing a substrate on which a graft polymer has been formed in a solution or dispersion liquid of electrically conductive particles each having an electric charge on the surface thereof.

In order to supply an excess amount of the electrically conductive particles to the interactive group(s) and form sufficient ionic bonds between the electrically conductive particles and the interactive groups (ionic groups) in either of the application or immersion process, the time when the solution or dispersion liquid is brought into contact with the graft polymer is preferably from about 10 seconds to about 24 hours, and more preferably from about one minute to about 180 minutes.

Moreover, it is preferable that the amount of the electrically conductive particles really bonded to the interactive group(s) of the graft polymer is a maxim adsorbable amount, from the viewpoints of durability and securance of electrical conductivity. To attain this, the concentration of the dispersion liquid is preferably in the range of about 0.001% to about 20% by mass.

In the process (1), it is preferable to heat the substrate having thereon a graft polymer that has adsorbed electrically conductive particles (heating treatment). The heating treatment causes fusion of the adsorbed electrically conductive particles, which enhances the adhesiveness between the electrically conductive particles and increases electrical conductivity of the particles.

The heating temperature in the heating treatment is preferably 50° C. to 500° C., more preferably 100° C. to 300° C., and most preferably 150° C. to 300° C.

(2) Formation of Plating Film

In the aforementioned process (2), at least one electroless plating catalyst or precursor thereof is adsorbed by the interactive group(s) of the graft polymer, and electroless plating is then conducted to form at least one plating film.

A way for causing the graft polymer to adsorb the electroless plating catalyst(s) or the precursor(s) thereof in the process (2) is described below.

The electroless plating catalyst used in this process is mainly a metal having a valence of 0 such as Pd, Ag, Cu, Ni, Al, Fe or Co. The electroless plating catalyst is preferably Pd or Ag in the invention, since it is easy to handle and has high catalytic activity. The metal having a valence of 0 is adsorbed by (fixed to) the graft polymer by, for example, applying to the surface of the graft polymer a metal colloid having an electric charge so adjusted as to have interaction with the interacting group(s) of the graft polymer. In general, the metal colloid can be prepared by reducing metal ions in a solution including at least one surfactant and/or at least one protective agent having an electric charge. The electric charge of the metal colloid can be adjusted by the surfactant and/or protective agent. By allowing the metal colloid having an adjusted electric charge to interact with the interacting group(s) of the graft polymer, the metal colloid (electroless plating catalyst) can be adsorbed by the graft polymer.

The electroless plating catalyst precursor(s) used in the process (2) chemically changes to form an electroless plating catalyst, and otherwise there is no limit thereto. The electroless plating catalyst precursor is mainly the ion of a metal having a valence of 0 that is the same as that used as the electroless plating catalyst. The metal ions serving as the electroless plating catalyst precursor are reduced into the metal having a valence of 0 serving as the electroless plating catalyst. The metal ions that have been adsorbed by the graft polymer may be reduced into the metal having a valence of 0 before the substrate is immersed in an electroless plating bath. Alternatively, the metal ions that have been adsorbed by the graft polymer may be converted into the metal (electroless plating catalyst) by immersing the substrate having thereon the graft polymer in an electroless plating bath and reducing the metal ions with the reducing agent contained in the bath.

Practically, the metal ions are adsorbed by the graft polymer in the form of a metal salt. The metal salt used needs to be dissolved in an appropriate solvent to dissociate into metal ions and a base (anion), and otherwise there is no limit thereto. Examples of the metal salt include M(NO₃)ₙ, Maₙ, M_{2/n}(SO₄), and M_{3/n}(PO₄). Here, M represents a metal atom having a valence of n. The metal ions are preferably the same as those obtained by the dissociation of the metal salt. Specific examples of such metal ions include Ag ions, Cu ions, Al ions, Ni ions, Co ions, Fe ions, and Pd ions. The metal ions are preferably Ag ions and/or Pd ions from the viewpoint of catalytic activity.

In order to provide the metal colloid serving as the electroless plating catalyst or the metal salt serving as the electroless plating catalyst precursor to the graft polymer, a solution of the metal ions obtained by the dissociation may be prepared by dispersing the metal colloid in an appropriate dispersion medium or dissolving a metal salt in an appropriate solvent and may be applied to the substrate surface having a graft polymer thereon. Alternatively, the substrate having a graft polymer thereon may be immersed in the above solution. By bringing the solution containing the metal ions into contact with the substrate, the metal ions can be adsorbed by the interacting group(s) of the graft polymer or can be impregnated into the graft polymer due to ion-ion interaction or dipole-ion interaction. In order to sufficiently conduct this adsorption or impregnation, the concentration of the metal ions or the metal salt(s) in the solution to be brought into contact with the substrate is preferably from 0.01 to 50% by mass, and more preferably from 0.1 to 30% by mass. The time during which the solution is brought into contact with the substrate is preferably from about one minute to about 24 hours, and more preferably from about five minutes to about one hour.

Next, electroless plating in the process (2) will be explained.

The graft polymer which has adsorbed the electroless plating catalyst(s) and/or precursor(s) thereof is subjected to electroless plating to form at least one electroless plating film.

Electroless plating is the procedure where a metal is precipitated from a solution containing the ions thereof by chemical reaction.

The electroless plating is carried out, for example, by washing the substrate having thereon the electroless plating catalyst(s) with water to remove extra electroless plating catalyst(s) (metal(s)), and then immersing the substrate in an electroless plating bath. The electroless plating bath used herein may be any known electroless plating bath.

When the substrate having thereon the graft polymer which has adsorbed the electroless plating catalyst precursor(s) is immersed in an electroless plating bath without preliminary treatment for reducing the precursor, the substrate is washed with water to remove extra precursor(s) (for example, metal salt(s)), and then immersed in the electroless plating bath. In this case, the precursor is first reduced and electroless plating is subsequently conducted in the electroless plating bath. The electroless plating bath used herein may be any known electroless plating bath.

In general, the electroless plating bath mainly includes (1) one or more kinds of plating metal ions, (2) at least one reducing agent, and (3) at least one additive (stabilizer) for stabilizing the plating metal ions. This plating bath may further contain any other known additive(s) such as a plating bath stabilizer.

As the metal containable in the electroless plating bath, copper, tin, lead, nickel, gold, palladium and rhodium are known. The metal(s) is preferably copper and/or gold from the viewpoint of electrical conductivity.

The kinds of the reducing agent(s) and the additive(s) are selected according to the kind of the metal(s) used. For example, an electroless copper plating bath contains Cu(SO₄)₂ serving as a copper salt, HCOH serving as a reducing agent, and a chelating agent, which is a copper ion stabilizer and serves as an additive, such as EDTA or Rochelle salt. A plating bath for use in electroless plating of CoNiP contains cobalt sulfate and nickel sulfate serving as metal salts, sodium hypophosphite serving as a reducing agent, and sodium malonate, sodium malate and sodium succinate serving as complex-forming agents. An electroless palladium plating bath contains (Pd(NH₃)₄)Cl₂ serving as metal ions, NH₃ and H₂NNH₂ serving as reducing agents, and EDTA serving as a stabilizer. These plating baths may contain components other than the aforementioned components.

The thickness of the electroless plating film thus formed can be controlled by adjusting, for example, the concentration of the metal salt(s) or metal ions in the plating bath, the time of immersion in the plating bath, and/or the plating bath temperature, and is preferably 0.5 μm or more, and more preferably 3 μm or more from the viewpoint of electrical conductivity. The time of immersion in the plating bath is preferably from about one minute to about 3 hours, and more preferably from about one minute to about one hour.

A sectional photograph of the electroless plating film obtained by SEM shows that electroless plating catalyst particles and the plating metal particles are dispersed in the graft polymer layer and densely exist therein and that relatively large particles deposit on these particles. Since the interface between the graft polymer and the plating film was in a hybrid state of the graft polymer and the particles, the adhesiveness between the substrate and the electroless plating catalyst or the plating metal is strong.

In the process (2), electroplating can be conducted after the completion of the electroless plating. More specifically, electroplating is conducted using as an electrode the electroless plating film obtained by the electroless plating.

The electroplating in the process (2) may be conducted by a known method. Examples of the metal(s) used in the electroplating include copper, chromium, lead, nickel, gold, silver, tin and zinc. The metal(s) is preferably copper, gold and/or silver, and more preferably copper from the viewpoint of electrical conductivity.

The thickness of the metal film obtained by the electroplating depends on the application of an electrically conductive pattern, and can be controlled by adjusting, for example, the concentration of the metal(s) contained in the plating bath, immersion time, and/or current density. When the electrically conductive pattern obtained by the invention is used in printed electric wiring, the thickness is preferably 0.3 μm or larger, and more preferably 3 μm or larger from the viewpoint of electrical conductivity.

(3) Formation of Metal Particle-Dispersed Layer

In the process (3), metal ions and/or a metal salt or salts, which will be described later, are ionically adsorbed by the interactive group(s), which is preferably an ionic group, of the graft polymer according to the polarities of the metal ions or the metal salt(s), and the metal ions, or the metal ions in the metal salt(s) are reduced to deposit the elemental metal and form a metal particle-dispersed layer.

Metal Ion and Metal Salt

First, the metal ions and the metal salt(s) used in the process (3) will be described.

In the invention, the metal salt(s) needs to be dissolved in an appropriate solvent to dissociate into a base (anion) and metal ions, which are to be adsorbed by the graft polymer, and otherwise there is no limit thereto. Examples thereof include M(NO₃)ₙ, MClₙ, M_{2/n}(SO₄) and M_{3/n}(PO₄). Here, M refers to a metal atom having a valence of n. The metal ions used in the process (3) can be the same as those obtained by the dissociation of the metal salt(s). Specific examples thereof include Ag, Cu, Al, Ni, Co, Fe and Pd ions. The metal ions are preferably Ag ions and/or Cu ions.

Only one of these metal salts and metal ions may be used, or, to obtain a desired electrical conductivity, two or more of them can be used together.

Providing of Metal Ion and/or Metal Salt

When the metal ions and/or the metal salt(s) is provided to a graft polymer having at least one ionic group (case 1), the ionic group is caused to adsorb the metal ions. In this case, a solution containing the metal ions obtained by dissociation of the metal salt(s) may be prepared by dissolving the metal salt(s) in an appropriate solvent. Thereafter, the solution may be applied to the graft polymer selectively formed on the substrate. Alternatively, the substrate having thereon a graft polymer may be immersed in the solution. By bringing the solution containing the metal ions into contact with the substrate, the metal ions can be ionically adsorbed by the ionic group(s). In order to sufficiently conduct this adsorption, the concentration of the metal ions in the solution brought into contact with the substrate is preferably from 1 to 50% by mass, and more preferably from 10 to 30% by mass. The time during which the solution is brought into contact with the substrate is preferably from about 10 seconds to about 24 hours, and more preferably from about one minute to about 180 minutes.

When the metal ions and/or the metal salt(s) is attached to (adsorbed by) a graft polymer having a high affinity with the metal salt(s), such as polyvinyl pyrrolidone, (case 2), the metal salt is directly attached to the graft polymer in the form of particles thereof. Alternatively, a dispersion liquid in which the metal salt particles are dispersed in an appropriate solvent is applied to the substrate surface having thereon a graft polymer, or the substrate having thereon a graft polymer is immersed into the dispersion liquid.

When the metal ions and/or the metal salt(s) is attached to a graft polymer having at least one hydrophilic group and therefore having high water retentivity (case 3), the graft polymer layer is preferably impregnated with a dispersion liquid in which the metal salt particles are dispersed due to the high water retentivity. More specifically, the dispersion liquid or a solution of the metal salt(s) is applied to the substrate surface having thereon the graft polymer, or the substrate having thereon such a graft polymer is immersed into the dispersion liquid or the solution.

From the viewpoint of sufficient impregnation of the graft polymer layer with the dispersion liquid or the solution, the concentration of the metal ions and/or the metal salt(s) in the dispersion liquid to be brought into contact with the substrate is preferably from 1% to 50% by mass, and more preferably 10 to 30% by mass. The contact time is preferably from about 10 seconds to about 24 hours, and more preferably from about one minute to about 180 minutes.

Regardless of the characteristics of the interactive group(s) of the graft polymer, desired metal ions and/or a desired metal salt or salts can be attached to the graft polymer in case 3.

### Reducing Agent

Next, the reducing agent(s) used to reduce the metal salt(s) and/or the metal ions adsorbed by or impregnated into the graft polymer (layer) will be explained.

The reducing agent(s) that can be used in the invention needs to have physical properties for reducing the metal ions and causing the resultant elemental metal to precipitate, and otherwise there is no limit thereto. Examples of the reducing agent(s) employable herein include hypophosphites, tetrahydroborates, and hydrazine.

The type of the reducing agent may be properly selected according to the type of the metal salt(s) and/or the metal ions used. For example, when an aqueous solution of silver nitrate is used as an aqueous solution of a metal salt for supplying metal ions and/or the metal salt, the reducing agent is preferably sodium tetrahydroborate. When an aqueous solution of palladium dichloride is used, the reducing agent is preferably hydrazine.

The reducing agent(s) can be attached to the metal ions and/or the metal salt(s) by washing a substrate locally having thereon a graft polymer that has adsorbed metal ions and/or a metal salt or salts with water to remove extra metal ions and/or metal salt(s), immersing the substrate in water such as deionized water, and then adding at least one reducing agent to water. Alternatively, the attachment of the reducing agent(s) can also be conducted by directly applying an aqueous solution of at least one reducing agent having a predetermined concentration to a substrate surface or dripping such an aqueous solution of at least one reducing agent on a substrate surface. It is preferable that the molar amount of the reducing agent(s) added is excessively higher than the molar amount of the metal ions. It is more preferable that the molar amount of the reducing agent(s) is at least 10 times higher than the molar amount of the metal ions.

The relationship between the interactive group(s) of the graft polymer and the metal ions and/or the metal salt(s) in the process (3) will be described below.

When the interactive group(s) of a graft polymer is a polar group having a negative charge or an ionic group having an anionic property such as a carboxyl group, a sulfonic acid group or a phosphonic acid group, the graft polymer layer selectively has a negative charge. Accordingly, metal ions having a positive charge are adsorbed by the layer, and then reduced to deposit the elemental metal.

When the interactive group(s) of the graft polymer is an ionic group having a cationic property, such as an ammonium group, as described in JP-A No. H10-296895, the graft polymer layer selectively has a positive charge, and metal ions themselves are not adsorbed by the graft polymer. For this reason, the graft polymer layer is impregnated with a dispersion liquid or a solution of a metal salt or salts utilizing the hydrophilicity of the ionic group(s) of the interactive group(s), and the metal ions or the metal salt(s) in the liquid is reduced to deposit the elemental metal.

As described above, a metal particle-dispersed layer is formed by depositing an elemental metal.

The presence or absence of the deposited elemental metal (metal particles) in the metal particle-dispersed layer can be confirmed by visually checking whether the layer has a surface with metallic luster. The structure (form) of the layer can be checked by inspecting the surface of the layer with a transmission electron microscope or an atomic force microscope (AFM). The thickness of the metal pattern can be easily measured by a standard method such as a method using the cross section of the layer obtained by an electron microscope.

A microscopic photograph of the metal particle-dispersed layer shows that the metal particles are dispersed in the graft polymer layer and densely exist therein. Here, the average size of the deposited metal particles is about 1 μm to about 1 nm.

In the case where the metal particle-dispersed layer has metal particles that are dispersed and densely exist therein and appears to be a continuous thin metal layer, the metal particle-dispersed layer may be used without conducting any treatment. However, in order to ensure a desired electrical conductivity, the metal particle-dispersed layer is preferably heated.

The heating temperature in this heating is preferably 100° C. or more, more preferably 150° C. or more, and still more preferably about 200° C. The heating temperature is preferably 400° C. or less, considering treatment efficiency or the dimensional stability of the support. The heating time is preferably 10 minutes or more, and more preferably from about 30 minutes to about 60 minutes.

The mechanism of action of the heat treatment is not yet definite. However, it is thought that the heating fuses some adjacent metal particles to enhance the electrical conductivity of the metal particle-dispersed layer.

(4) Formation of Electrically Conductive Polymer Layer

In the process (4), the interactive group(s), preferably an ionic group, of a graft polymer ionically adsorbs at least one electrically conductive monomer, which will be described later, and the monomer is polymerized to form an electrically conductive polymer layer. A more concrete process for forming an electrically conductive polymer layer is not specifically limited, but the following process is preferred from the viewpoint of formation of a uniform thin film.

First, a substrate having thereon a graft polymer is immersed into a solution containing at least one polymerization catalyst and/or at least one compound capable of initiating polymerization, such as potassium persulfate or ferric sulfate. The monomer(s) of an electrically conductive polymer, such as 3,4-ethylenedioxythiophene, is gradually dripped into the solution, which is being stirred. By this procedure, the interactive group(s) (ionic group) of the graft polymer to which the polymerization catalyst or the compound capable of initiating polymerization is attached firmly adsorbs the monomer(s) of an electrically conductive polymer due to interaction therebetween, and the monomer(s) is polymerized to form a very thin layer of an electrically conductive polymer on the graft polymer layer formed on the substrate. A thin and uniform electrically conductive polymer layer is thus formed.

The electrically conductive polymer that can be used in the process may be any polymeric compound having an electrical conductivity of 10⁻⁶ s·cm⁻¹ or higher, preferably 10⁻¹ s·cm⁻¹ or higher. Specific examples thereof include substituted or unsubstituted electrically conductive polyaniline, polyparaphenylene, polyparaphenylene vinylene, polythiophene, polyfuran, polypyrrole, polyselenophene, polyisothianaphthene, polyphenylene sulfide, polyacetylene, polypyridyl vinylene and polyazine. Only one of these compounds may be used, or two or more of them can be used together in accordance with the intended use of the electrically conductive pattern. Moreover, a mixture of the electrically conductive polymer(s) and other polymer(s) having no electrical conductivity, and/or a copolymer of the above monomer(s) and other monomer(s) having no electrical conductivity may be used, as long as a desired electrical conductivity can be obtained.

In the invention, an electrically conductive monomer itself has an electrostatic or polar interaction with respect to the interactive group(s) of a graft polymer and is firmly adsorbed by the interactive group(s). Accordingly, the electrically conductive polymer layer formed by polymerizing the electrically conductive monomer strongly interacts with the graft polymer layer, and, even if the layer is thin, has sufficient resistance to rubbing and scratch.

Moreover, when the electrically conductive polymer and the interactive group(s) of the graft polymer are so selected to have a relationship between cation and anion, the interactive group, which absorbs the electrically conductive polymer, is the counter ion of the electrically conductive polymer and serves as a kind of a dopant. Accordingly, the interactive group(s) results in an improved electrical conductivity of the electrically conductive polymer layer (electrically conductive pattern). For example, when styrenesulfonic acid is used as a polymerizable compound having at least one interactive group and thiophene is used as the raw material of an electrically conductive polymer, polythiophene having at least one sulfonic acid group (sulfo group) serving as the counter anion of the electrically conductive polymer is formed at the interface between the graft polymer layer and the electrically conductive polymer layer due to the interaction between the polymerizable compound and the raw material, and serves as a dopant for the electrically conductive polymer.

The thickness of the electrically conductive polymer layer formed on the graft polymer layer is not specifically limited, but is preferably in the range of 0.01 μm to 10 μm, and more preferably in the range of 0.1 μm to 5 μm. When the thickness of the electrically conductive polymer layer is within this range, both sufficient electrical conductivity and transparency of the electrically conductive polymer layer can be achieved. An electrically conductive polymer layer having a thickness of less than 0.01 μm may have an insufficient electrical conductivity.

The electrically conductive pattern obtained by the invention can have any pattern by selecting the type of a unit for disposing a liquid in a pattern and the type of a unit for attaching an electrically conductive substance to a graft polymer. Accordingly, the electrically conductive pattern can be used to form various circuits such as metal circuit boards and printed circuit boards, and is expected to have widespread application including transparent electrodes for display devices, electromagnetic wave shield filters, light-modulating devices, solar batteries and touch-sensitive panels.

### EXAMPLES

Hereinafter, the invention will be illustrated while referring to Examples. However, the invention is not limited to these Examples.

Synthesis 1 (Synthesis of Compound A)

The synthesis of compound A was conducted by the following two steps.

1. Step 1 (Synthesis of Compound (a))

In a container, 24.5 g (0.12 mol) of 1-hydroxycyclohexylphenylketone was dissolved in a mixed solvent of 50 g of DMAc and 50 g of THF, and 7.2 g (0.18 ml) of NaH in the form of an oily solution having a concentration of 60% by mass was gradually added to the resultant solution contained in the container, which was being put in an ice bath. Then, 44.2 g (0.18 mol) of 11-bromo-1-undecen (95%) was dripped into the resultant mixture, and the components of the mixture were allowed to react at room temperature. The reaction completed in one hour. The reaction solution was poured into iced water, and the reaction product was extracted with ethyl acetate to obtain a yellow solution. Thirty-seven grams of the solution was dissolved in 370 ml of acetonitrile, and 7.4 g of water was added to the resultant solution. Thereafter, 1.85 g of p-toluenesulfonic acid monohydrate was added to the obtained mixture, and the resulting blend was stirred at room temperature for 20 minutes. Some of the components in the organic phase of the blend were extracted with ethyl acetate, and the solvent was removed by evaporation from the extract. The remaining was subjected to column chromatography containing, as a filler, WAKO GEL C-200, using a mixture of ethyl acetate and hexane at a mass ratio of 1/80 as a developing solvent. Thus, a compound (a) was isolated.

2. Step 2 (Synthesis of Compound A by Hydrosilylation of Compound (a))

In a container, two drops of H₂PtCl₆.6H₂O/2-PrOH (SPEIR catalyst having a concentration of 0.1 mol/l) were added to 5.0 g (0.014 mol) of the compound (a) obtained in Step 1, and 2.8 g (0.021 mol) of trichlorosilane was dripped into the resultant mixture contained in the container, which was being put in an ice bath, and the obtained blend was stirred. One hour later, 1.6 g (0.012 mol) of trichlorosilane was dripped into the blend, and the container was taken out off the ice bath and the temperature of the content of the container was allowed to return to room temperature. A reaction completed after three hours. After the completion of the reaction, unreacted trichlorosilane was removed by vacuum evaporation from the reaction system, and a compound A having the following structure was obtained.

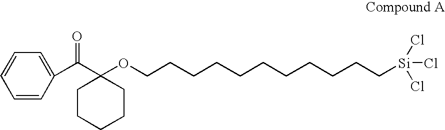

Synthesis 2 (Synthesis of Polymer P Having Hydrophilic Group and Radically Polymerizable Unsaturated Group)

Eighteen grams of polyacrylic acid (average molecular weight of 25,000) was dissolved in 300 g of dimethyl acetamide (DMAc). Thereafter, 0.41 g of hydroquinone, 19.4 g of 2-methacryloyloxyethyl isocyanate and 0.25 g of dibutyltin dilaurate were added to the resultant solution, and the components of the obtained mixture were reacted at 65° C. for four hours. A polymer having carboxyl groups and an acid value of 7.02 meq/g was obtained. The carboxyl groups were neutralized with one mol/liter of a sodium hydroxide aqueous solution, and the resultant system was added to ethyl acetate to precipitate a product. The product was thoroughly washed. Thus, a polymer P having at least one hydrophilic group and at least one radically polymerizable unsaturated group was obtained.

### Example 1

### Liquid Disposition

Preparation of Substrate Capable of Generating Radicals by Heating or Exposure

A glass substrate (manufactured by Nippon Sheet Glass Co., Ltd.) was immersed into a piranha solution (mixed solution of sulfuric acid and 30% hydrogen peroxide at a volume ratio of 1/1) overnight, and then washed with pure water. The substrate was placed in a separable flask filled with nitrogen, and immersed into a 12.5 mass % solution in which the compound A was dissolved in dehydrated toluene for one hour. The substrate was taken out off the solution, and sequentially washed with toluene, acetone and pure water. A substrate (a1) was thus obtained.

Formation of Graft Polymer

Disposition of Liquid

0.5 g of the polymer P having at least one hydrophilic group and at least one radically polymerizable unsaturated group (radically polymerizable compound) was dissolved in a mixed solvent of 4.0 g of pure water and 2.0 g of acetonitrile to obtain a liquid for ink jetting. The viscosity of the liquid was about 10 mPa·s.

First, the substrate (a1) was disposed on the X-Y stage of an ink jet printer, which will be explained later, with the surface of the substrate on which a graft polymer was to be formed upward. While the substrate (a1) on the X-Y stage was moved, the droplets of the liquid were discharged from the ink jet nozzles of the ink jet printer to the surface to dispose the droplets in a predetermined pattern.

The ink jet printer was MJ-10000 manufactured by Seiko Epson Corporation. The ink jet head of the ink jet printer had 180 nozzles in each row. However, only one row of nozzles that were disposed along the long side (length) of the pattern were used. Droplets of the liquid were discharged from the nozzles under the following conditions. That is, the distance between the substrate surface and the end of each nozzle was 0.3 mm. The volume of one droplet was 10 ng. Thereby, the diameter of each of the discharged droplets was controlled within the range of 25 μm to 30 μm. The droplets were discharged at intervals of 20 μm (distance between droplet centers) in the long side direction of the pattern.

Drying

The substrate (a1) on which the droplets of the liquid had been disposed in the pattern was placed in a hot air oven, and heated at 100° C. for five minutes to dry the droplets and remove the solvent therefrom. A dry film containing a radically polymerizable compound was thus formed on the substrate (a1).

Graft Polymer Formation

Exposure

The entire of the surface of the substrate (a1) on which surface the dry film containing a radically polymerizable compound had been disposed was exposed to light for one minute with an exposing machine (UVX-02516SILP01 manufactured by Ushio Inc.). After the exposure, the substrate was thoroughly washed with pure water. Thus, a graft polymer bonded to the substrate was formed, and a graft polymer pattern (g1) (having regions where the graft polymer was formed and regions where the graft polymer was not formed) was formed.

### Example 2

### Preparation of Substrate Capable of Generating Radicals by Heating or Exposure

A PET film (biaxially oriented polyethylene terephthalate film) that had a thickness of 188 μm and whose surface had been subjected to corona treatment was cut to obtain a piece having a size of 5 cm×5 cm, and the piece was placed in a separable flask filled with nitrogen, and immersed into a 12.5 mass % solution in which the compound A was dissolved in dehydrated toluene for one hour. The piece was taken out off the solution, and sequentially washed with toluene, acetone and pure water. A substrate (a2) was thus obtained.

Formation of Graft Polymer

A graft polymer was formed on the substrate (a2) in the same manner as the graft polymer in Example 1, and a graft polymer pattern (g2) (having regions where the graft polymer was formed and regions where the graft polymer was not formed) was formed.

### Example 3

A graft polymer pattern (g3) was formed in the same manner as in Example 1, except that the liquid containing the polymer P having at least one hydrophilic group and at least one radically polymerizable unsaturated group was disposed in a pattern on the surface of the substrate (a1) by a stamp process.

The stamp (rubber stamp) used to dispose the liquid in a pattern was prepared by coating the surface of a silicone rubber plate with a resist, and etching the resist to form a pattern having lines whose width was 150 μm and spaces whose width was 150 μm between the lines.

Evaluation of Accuracy of Pattern

The accuracy of each of the graft polymer patterns (g1) to (g3) thus obtained was evaluated by the following methods (1) and (2).

Method (1): The graft polymer patterns (g1) to (g3) were inspected with an atomic force microscope (AFM) (NANOPIX 1000 manufactured by Seiko Instruments Inc., and equipped with a DFM cantilever). The minimum of the widths of lines of each pattern, which lines could be resolved, is shown in Table 1.

Method (2): The graft polymer patterns (g1) to (g3) were immersed into a 0.1 mass % methylene blue aqueous solution for five minutes, and washed with pure water. Thereafter, the patterns (g1) to (g3) were checked with an optical microscope. The minimum of the widths of lines of each pattern, which lines could be resolved, is shown in Table 1.

TABLE 1

| | | Minimum line width | Minimum line width |
|---|---|---|---|
| | Graft polymer | obtained by | obtained by |
| | pattern | Method (1) | method (2) |
| Example 1 | g1 | 20 μm | 20 μm |
| Example 2 | g2 | 18 μm | 18 μm |
| Example 3 | g3 | 150 μm | 150 μm |

As is evident from Table 1, each of the graft polymer patterns (g1) to (g3) obtained by the method for forming a graft polymer pattern of the invention was a fine pattern. It was found that an ink jet method can produce a particularly fine pattern.

### Example 4

A graft pattern (a1′) (having regions where the graft polymer was formed and regions where the graft polymer was not formed) was formed in the same manner as in Example 1, except that the exposure time was changed to three minutes.

Electrically Conductive Substance Attachment

A substrate having thereon the graft polymer pattern (a1′) was immersed into a 0.1 mass % aqueous solution of palladium nitrate (manufactured by Wako Pure Chemical Industries, Ltd.) for one hour, and then washed with distilled water. Subsequently, the substrate was immersed into an electroless plating bath having the following composition for 20 minutes to form a Cu plating film. An electrically conductive pattern was thus obtained.

<Composition of Electroless Plating Bath>

| | |
|---|---|
| OPC Copper H T1 (manufactured by Okuno Chemical Industry | 6 mL |
| Co., Ltd.) | |
| OPC Copper H T2 (manufactured by Okuno Chemical Industry | 1.2 mL |
| Co., Ltd.) | |
| OPC Copper H T3 (manufactured by Okuno Chemical Industry | 10 mL |
| Co., Ltd.) | |
| Water | 83 mL |

The electrically conductive pattern was inspected with an optical microscope (OPTI PHOTO-2 manufactured by Nikon Corporation). As a result; it was confirmed that the electrically conductive pattern made of copper had lines whose width was 20 μm and spaces whose width was 20 μm and was therefore good. The electrical conductivity of the electrically conductive pattern, which was the Cu plating film, was measured by a four-point probe method with LORESTA-FP (manufactured by Mitsubishi Chemical Corporation) and found to be 0.3 Ω/□.

The surface of the electrically conductive pattern was manually rubbed back and forth for 20 cycles with a cloth (BEMCOT manufactured by Asahi Chemical Industry Co., Ltd.) impregnated with water. After the rubbing, the surface was checked with an optical microscope in the same manner as the described above. As a result, it was confirmed that the rubbed electrically conductive pattern was as good as that before the rubbing treatment. Moreover, the electrical conductivity of the rubbed Cu plating film showed no change.

### Example 5

An application liquid for a radical-generating agent-containing layer having the following composition was applied to the surface of a polyimide film having a thickness of 200 μm (KAPTON film manufactured by Du Pont) and used as a substrate with a rod bar No. 18, and the resultant coating was dried at 80° C. for two minutes to form a radical-generating agent-containing layer having a thickness of 6 μm. The surface of the substrate on which surface the radical-generating agent-containing layer was formed was exposed to light emitted by a high-pressure mercury vapor lamp having an output of 400 W (UVL-400P manufactured by Riko-Kagaku Sangyo Co., Ltd.) for 10 minutes to preliminarily cure the radical-generating agent-containing layer. Thus, a substrate (a2′) was obtained. The surface roughness (Rz) of the substrate (a2′) was measured and found to be 12 nm.

| | |
|---|---|
| Composition of Application Liquid for Radical-Generating | 2 g |
| Agent-Containing Layer Allyl methacrylate/methacrylic | |
| acid copolymer (molar ratio of the former monomer and the | |
| latter monomer of 80/20, and average molecular weight of | |
| 100,000) | |
| Bisphenol A diacrylate modified with ethylene oxide | 4 g |
| (IR125 manufactured by Wako Pure Chemical Industries, Ltd.) | |
| 1-hydroxycyclohexyl phenyl ketone | 1.6 g |
| 1-methoxy-2-propanol | 16 g |

An electrically conductive pattern was obtained in the same manner as in Example 4, except that the substrate (a2′) was used in place of the substrate (a1′), and except that the substrate on which the graft pattern had been formed in the electrically conductive substance attachment was immersed into a 0.1 mass % silver nitrate (manufactured by Wako Pure Chemical Industries, Ltd.) solution for one hour, washed with distilled water, and subjected to electroless plating in an electroless plating bath having the following composition for 20 minutes to form a Cu plating film.

Composition of Electroless Plating Bath

| | | |
|---|---|---|
| Copper sulfate | 38 | g |
| Sulfuric acid | 95 | g |
| Hydrochloric acid | 1 | mL |
| Copper Gleam PCM (manufactured by Meltex Inc.) | 3 | mL |
| Water | 500 | g |

The electrically conductive pattern was inspected with an optical microscope (S 700 manufactured by JEOL Ltd.). As a result, it was confirmed that the electrically conductive pattern made of copper had lines whose width was 20 μm and whose height was 13 μm and spaces whose width was 20 μm and was therefore good. The electrical conductivity of the electrically conductive pattern, which was the Cu plating film, was measured with LORESTA-FP (manufactured by Mitsubishi Chemical Corporation) and found to be 4 μΩ·cm.

The surface of the electrically conductive pattern was manually rubbed back and forth for 20 cycles with a cloth (BEMCOT manufactured by Asahi Chemical Industry Co., Ltd.) impregnated with water. After the rubbing, the surface was checked with an optical microscope in the same manner as the described above. As a result, it was confirmed that the rubbed electrically conductive pattern was as good as that before the rubbing treatment. Moreover, the electrical conductivity of the rubbed Cu plating film showed no change.

### Example 6

An electrically conductive pattern was obtained in the same manner as in Example 4, except that the electrically conductive substance attachment was conducted as follows.

Electrically Conductive Substance Attachment

The substrate having the graft polymer pattern (a1′) obtained in Example 4 was immersed into an Ag particle dispersion liquid having a positive charge, which had been prepared in the manner described below, and the surface was then thoroughly washed with running water to remove extra particle dispersion liquid. Thus, an electrically conductive particle-adsorbed layer having electrically conductive particles adsorbed by the graft polymer pattern was obtained. In order to improve the electrical conductivity of the layer, the substrate having thereon the electrically conductive particle-adsorbed layer was heated at 300° C. for 30 minutes to fuse the particles.

Preparation of Ag Particle Dispersion Liquid

Three grams of bis(N,N,N-trimethylammonium decanoylaminoethyl) disulfide was added to 50 ml of a solution in which silver perchlorate was dissolved in ethanol and whose concentration was 5 mmol/l. Thirty milliliters of a sodium borohydride solution (0.4 ml/l) was slowly dripped into the resultant solution, which was being vigorously stirred, to reduce silver ions. Thus, a dispersion liquid of silver particles coated with quaternary ammonium was obtained. The average size of the silver particles was measured with an electron microscope, and found to be 5 nm.

The electrically conductive pattern was inspected with an optical microscope (OPTI PHOTO-2 manufactured by Nikon Corporation). As a result, it was confirmed that the electrically conductive pattern, or a silver thin film, had lines whose width was 20 μm and spaces whose width was 20 μm. The electrical conductivity of the electrically conductive pattern (silver thin film) was measured by a four-point probe method with LORESTA-FP (manufactured by Mitsubishi Chemical Corporation) and found to be 1.5 Ω/□.

The surface of the electrically conductive pattern was manually rubbed back and forth for 20 cycles with a cloth (BEMCOT manufactured by Asahi Chemical Industry Co., Ltd.) impregnated with water. After the rubbing, the surface was checked with an optical microscope in the same manner as the described above. As a result, it was confirmed that the rubbed electrically conductive pattern was as good as that before the rubbing treatment. Moreover, the electrical conductivity of the rubbed silver thin film showed no change.

### Example 7

An electrically conductive pattern was obtained in the same manner as in Example 4, except that a stamp process was used to dispose in a pattern the liquid containing the polymer P having at least one hydrophilic group and at least one radically polymerizable unsaturated group on the graft polymer pattern (a1′) formed on the substrate.

The stamp (rubber stamp) used to dispose the liquid was prepared by coating the surface of a silicone rubber plate with a resist, and etching the resist to form a pattern with lines having a width of 200 μm and spaces having a width of 200 μm between the lines.

The electrically conductive pattern was inspected with an optical microscope (S 700 manufactured by JEOL Ltd.). As a result, it was confirmed that the electrically conductive pattern made of copper had lines whose width was 200 μm and whose height was 2 μm and spaces whose width was 200 μm and was therefore good. The electrical conductivity of the electrically conductive pattern, which was the copper plating film, was measured with LORESTA-FP (manufactured by Mitsubishi Chemical Corporation) and found to be 10 μΩ·cm.

The surface of the electrically conductive pattern was manually rubbed back and forth for 20 cycles with a cloth (BEMCOT manufactured by Asahi Chemical Industry Co., Ltd.) impregnated with water. After the rubbing, the surface was checked with an optical microscope in the same manner as the described above. As a result, it was confirmed that the rubbed electrically conductive pattern was as good as that before the rubbing treatment. Moreover, the electrical conductivity of the rubbed copper plating film showed no change.

1. A method for forming a graft polymer pattern comprising disposing in a pattern a liquid containing a radically polymerizable unsaturated compound on a substrate surface capable of generating radicals by heating or exposure, and heating or exposing the substrate to form a graft polymer directly bonded to the substrate surface in a region where the liquid has been disposed.

2. The method for forming a graft polymer pattern of claim 1, wherein disposing in the pattern the liquid containing a radically polymerizable unsaturated compound on the substrate surface is conducted by a process selected from the group consisting of an ink jet process, a stamp process and a printing process.

3. A method for forming an electrically conductive pattern comprising:
disposing in a pattern a liquid containing a radically polymerizable unsaturated compound on a substrate surface that can generate radicals by heating or exposure;
heating or exposing the substrate to form a graft polymer directly bonded to the substrate surface in a region where the liquid has been disposed; and
attaching an electrically conductive substance to the graft polymer.

4. The method for forming an electrically conductive pattern of claim 3, wherein disposing in the pattern the liquid containing a radically polymerizable unsaturated compound on the substrate surface is conducted by a process selected from the group consisting of an ink jet process, a stamp process and a printing process.
